(19) United States
(12) Patent Application Publication
(10) Pub. No.: US 2008/0152049 A1
(43) Pub. Date: Jun. 26, 2008

(54) Digital audio broadcast receiver

(75) Inventors: Harald Sandner, Marzling (DE); Ajaib Hussain, Freising (DE)

Correspondence Address: TEXAS INSTRUMENTS INCORPORATED, P O BOX 655474, M/S 3999, DALLAS, TX, 75265, US

(73) Assignee: TEXAS INSTRUMENTS DEUTSCHLAND GMBH, Freising (DE)

(21) Appl. No.: 11/953,674

(22) Filed: Dec. 10, 2007

(30) Foreign Application Priority Data
Dec. 8, 2006 (DE) 10 2006 057 960.7

(51) Int. Cl. H04L 27/06

(52) U.S. Cl. 375/344

(57) ABSTRACT

A digital audio broadcast (DAB) receiver (10) for receiving an RF signal comprises a low noise amplifier (16), an RF mixer (24) that generates an intermediate frequency signal, and a voltage controlled oscillator (23). The receiver includes a tracking filter (18) downstream of the low noise amplifier (16) and upstream of the RF mixer (24), wherein the tracking filter is tuned to track a selected channel frequency out of the received RF signal. In a described embodiment, the tracking filter includes a bandpass filter (20) and a notch filter (22). A center frequency of the bandpass filter is tuned to track the selected channel frequency; and an attenuation notch of the notch filter is tuned to track a frequency which is separated from the selected channel frequency by a fixed frequency; the attenuation notch of the notch filter is tuned together with the center frequency of the bandpass filter, and the center frequencies of the notch filter and the bandpass filter are separated by a fixed frequency. The tracking filter is tuned by a digital word developed by a digital signal processor responsive to the intermediate frequency signal.

This application claims priority from German Patent Application No. 10 2006 057 960.7, filed 8 Dec. 2006.

### FIELD OF THE INVENTION

This invention relates to a digital audio broadcast (DAB) receiver.

### BACKGROUND

The VHF range for digital audio broadcast (DAB) band III typically extends from 174 to 240 MHz. This frequency band is divided into a number of channels which are spaced from each other by about 1.5 to 1.9 MHz and which contain the information in a digitally coded form. In typical RF front end architectures, an input bandpass filter is provided between a receiver antenna and a low noise amplifier to limit the RF signal amplified to frequencies within the DAB frequency band. The low noise amplifier then amplifies the RF signal before it is mixed with a local oscillator signal in an RF mixer. The local oscillator is tunable, i.e., a voltage controlled oscillator is used, to down-convert the frequency of a selected channel to a lower constant intermediate frequency (IM). A typically used intermediate frequency IM is 38.912 MHz. With these values for the selected channel frequency and the intermediate frequency IM, the frequency of the local oscillator is tunable in a range of from 212.912 MHz to 278.912 MHz.

As is well known, the RF mixer produces an upper sideband comprising all frequencies equal to a sum of each distinct channel frequency inside the DAB frequency band passing through the input bandpass filter and the local oscillator's frequency, and a lower sideband comprising all frequencies equal to a difference of the local oscillator's frequency and each distinct channel frequency inside the DAB frequency band. With the frequencies cited above, the intermediate frequency IM is in the lower sideband. Only the intermediate frequency IM can pass a narrow bandpass filter downstream of the RF mixer, which is usually realized as a surface acoustic wave (SAW) filter.

By tuning the local oscillator, the lower and the upper sidebands are moved in the frequency range. The choice of the intermediate frequency is adapted to the DAB frequency band, so that for any oscillator frequency in the oscillator's tunable range, only one channel frequency leads to an RF mixer output at the intermediate frequency.

Today, RF frequencies are extensively used and there are powerful RF signals near the DAB frequency band. Therefore, there may be an RF signal at a frequency only slightly above the upper end of the DAB frequency band and which is therefore not sufficiently suppressed by the input bandpass filter. In such a configuration, for selected channels at the lower end of the DAB frequency band, such an RF signal produces a lower sideband signal at a frequency close or even equal to the intermediate frequency, and thus passes the narrow bandpass filter after the RF mixer and falls into the useful band after demodulation, leading to disturbed audio signals.

For example, when channel 13 is selected at channel frequency f13 which is 174.928 MHz, the frequency LO of the local oscillator is tuned to 213.84 MHz, and the RF mixer generates the intermediate frequency IM=LO−f13=38.912 MHz. The neighboring channel frequency f14 at 176.64 MHz generates a frequency in the RF mixer of 37.20 MHz which is already suppressed by the narrow bandpass filter. Now, if for any reason the RF input contains an RF signal component at a frequency of f13+2*IM=252.752 MHz, which is slightly outside the DAB band, the RF mixer produces a lower sideband signal at frequency f13+2*IM−LO=38.912 MHz=IM. Accordingly, the RF input signal component at 252.752 MHz produces interference in the useful band after demodulation.

To avoid interference from those RF input signals outside the wanted band, a highly selective RF bandpass filter of large order with a high Q factor can be used as an input bandpass filter. While this approach is successful, it is difficult to implement and expensive.

### SUMMARY

The invention provides a digital audio broadcast (DAB) receiver that provides a high rejection of RF input signals outside of, but close to, the upper end of the wanted RF band without the need for a large order, high Q RF bandpass filter.

Specifically, the inventive digital audio broadcast (DAB) receiver receiving an RF signal comprises a low noise amplifier, an RF mixer that generates an intermediate frequency, and a voltage controlled oscillator. The receiver further comprises a tracking filter downstream of the low noise amplifier and upstream of the RF mixer, wherein the tracking filter is tuned to track a selected channel frequency out of the received RF signal.

In one embodiment, the tracking filter comprises a tunable bandpass filter, the center frequency of which is tuned to track the selected channel frequency. As the bandpass filter is tuned, it can be designed as a rather narrow band filter without the need for high selectivity.

In another embodiment, the tracking filter comprises a tunable notch filter, an attenuation notch of which is tuned to track a frequency which is separated from the selected channel frequency by a fixed frequency.

In an example preferred embodiment, the tracking filter comprises a tunable bandpass filter and a notch filter, whereby the attenuation notch is tuned together with the center frequency of the tunable bandpass filter, and the center frequencies of the attenuation notch filter and the tunable bandpass filter are separated by a fixed frequency. In the specific preferred application, the fixed frequency is about twice the intermediate frequency. Thus, undesired RF frequencies which would mix with the frequency of the local oscillator to the intermediate frequency are reliably suppressed.

### BRIEF DESCRIPTION OF THE DRAWINGS

The new architecture and benefits of the invention will become apparent from the following detailed description of example embodiments, with reference to the accompanying drawings, wherein:

FIG. 1 is a schematic diagram of part of a digital audio broadcast (DAB) receiver, according to an example implementation of the principles for the invention;

FIG. 2 is a frequency diagram showing relevant frequencies and frequency bands;

FIG. 3 is a frequency diagram showing the frequencies for a selected channel;

FIG. 4 is a frequency diagram as in FIG. 3, illustrating frequency bandpassing by the input bandpass filter;

FIG. 5 is a frequency diagram as in FIG. 3, illustrating frequency bandpassing by the tunable bandpass filter and frequency band stopping by the notch filter.

### DETAILED DESCRIPTION OF EXAMPLE EMBODIMENTS

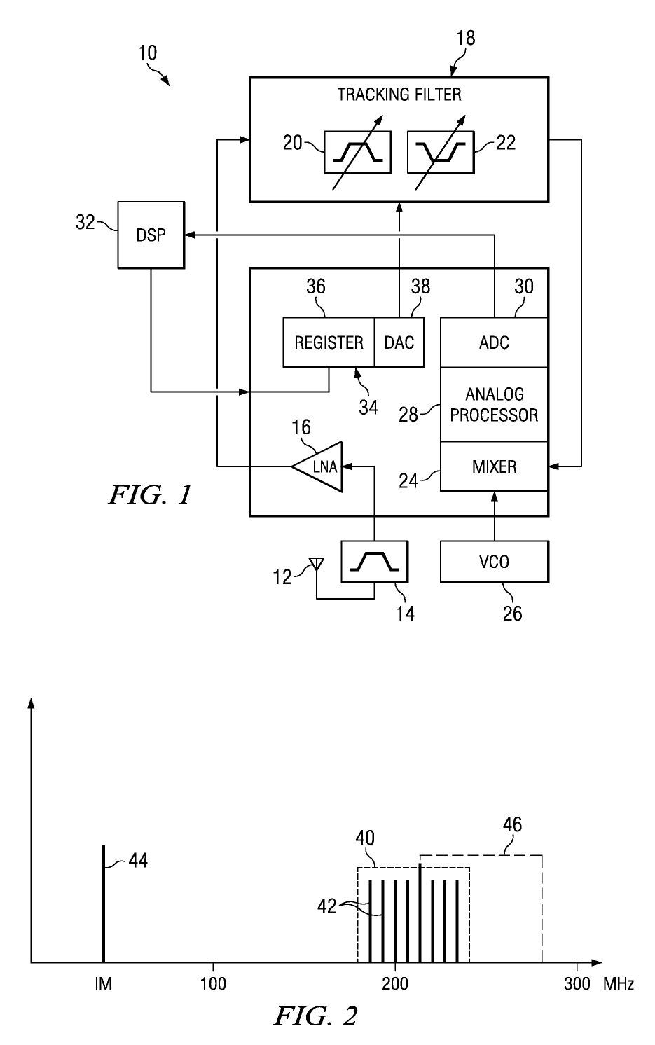

With reference to FIG. 1, a digital audio broadcast (DAB) receiver 10 receives an RF signal captured by a receiving antenna 12 and passes it through an RF input bandpass filter 14. The filtered RF signals are then amplified by a low noise amplifier (LNA) 16. The output of low noise amplifier 16 is connected to a tracking filter 18, which comprises a tunable bandpass filter 20 and a tunable notch filter 22. The output of tracking filter 18 is connected to a first input of an RF mixer 24. RF mixer 24 receives at a second input a frequency signal from a voltage-controlled oscillator 26. RF mixer 24 outputs a signal at the intermediate frequency IM. This signal containing the digitally coded information is first processed by an analog processor 28, including filtering and amplifying. The filter used for the intermediate frequency can be a surface acoustic wave (SAW) filter, as the intermediate frequency is constant and stable. SAW filters have a very narrow pass-band. The filtered and amplified analog signal is then converted to a digital signal by an analog-to-digital converter 30. The digital signal is then transmitted by a digital bus from analog-to-digital converter 30 to a digital signal processor (DSP) 32. In addition to the audio information, the digital signal includes frequency information about the selected channel. DSP 32 is connected via a serial interface bus to a voltage generator 34 including a register 36 which is writable via the serial interface and a digital-to-analog converter 38 which generates a tuning voltage to the tracking filter 18.

The DSP 32 contains a storage table with digital control words corresponding to selected channel frequencies. When the DSP 32 receives a digital signal from analog-to-digital converter 30, it uses the frequency information contained in the digital signal to look up the corresponding digital control word which it then supplies to the digital-to-analog converter 38, which generates a tuning voltage accordingly. The tuning voltage tunes the tunable bandpass filter 20 so that its center frequency is equal to the frequency of the channel selected, and tunes the notch filter 22 so that the attenuation notch of the notch filter is separated from the center frequency of the tunable bandpass filter by a fixed frequency which is twice the intermediate frequency.

The function of the digital audio broadcast receiver 10 is explained with reference to FIGS. 2 to 5.

FIG. 2 is a frequency diagram showing the frequency band 40 used in the digital audio broadcasting band III, extending from 174 to 240 MHz and comprising a plurality of distinct channel frequencies illustrated by frequency lines 42. To obtain an intermediate frequency (IM) 44 of 38.912 MHz, the frequencies of the voltage-controlled oscillator 26 are comprised of frequencies in a frequency band 46 between 212 and 279 MHz.

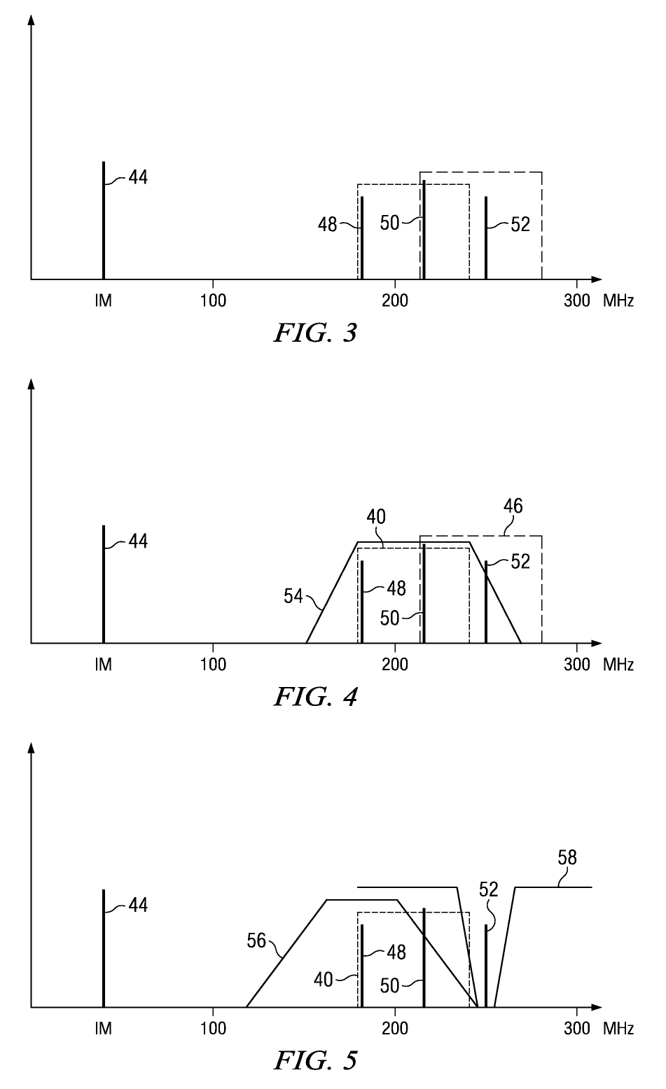

FIG. 3 shows by way of example a selected channel 48, which is the channel 13 in the DAB band with a frequency f13=174.928 MHz. The wanted channel is selected by the user by known means. According to the selection, the voltage controlled oscillator (VCO) 26 is set to a frequency 50 which is equal to the frequency f13 of the selected channel 13 plus the intermediate frequency IM 44. As channel 13 is at the lower end of the DAB frequency band III, the frequency 50 of local oscillator 26 is also at the lower end of the possible oscillator frequencies. In the RF mixer, these two frequencies will subtract to the intermediate frequency IM 44. It should be understood that all the other frequencies included in band III will also be input to RF mixer 24 and be down-converted and up-converted to frequencies in the lower sideband included between zero and the intermediate frequency and in the upper sideband included between 387 and 453 MHz. But only the channel frequency f13 will be down-converted to the intermediate frequency, and only that signal will pass the narrow bandpass SAW filter for further processing. But, if the receiver antenna 12 captures an interference signal at a frequency 52 of 252.752 MHz which is f13 plus twice IM and slightly outside the DAB band as indicated in FIG. 3, this interference frequency will be down-converted in RF mixer 24 to the intermediate frequency IM as it is distant from the local oscillator frequency by the intermediate frequency. Therefore, the down-converted interference frequency cannot be stopped by the SAW filter and will lead to a disturbed signal after demodulation.

FIG. 4 shows a frequency diagram with the same frequencies discussed above in connection with FIG. 3: the intermediate frequency 44, the selected channel frequency 48, the tuned oscillator frequency 50, and an interference signal frequency 52. Additionally, FIG. 4 shows schematically a bandpass configuration 54 of the RF input bandpass filter 14. It is designed for a passband covering the entire DAB frequency band III. Although interference frequency 52 is out-of-band it can pass the RF input bandpass filter 14 only slightly attenuated, the attenuation depending on the steepness of the filter edge. In the state of the art, the RF input filter is therefore realized by a high order filter which is very expensive.

FIG. 5 illustrates an example of the solution provided by the invention. Again, FIG. 5 shows the same frequencies as FIGS. 3 and 4: the intermediate frequency 44, the selected channel frequency 48, the tuned oscillator frequency 50, and an interference signal frequency 52. Additionally, FIG. 5 shows schematically a bandpass configuration 56 of the tunable bandpass filter 20, which is now centered on the selected channel frequency 48. Tunable bandpass filter 20 is designed with a narrower pass-band than the pass-band of RF input bandpass filter 14. Although the edges of this filter are less steep (a second order filter can be used), the interference frequency 52 is already well attenuated.

FIG. 5 also shows a bandpass configuration 58 used for the tunable notch filter 22 in a preferred example embodiment. The attenuation notch of notch filter 22 is tuned to track a frequency which is separated from the selected channel frequency by a fixed frequency. As only RF signals with a frequency which is separated from the selected channel frequency by twice the intermediate frequency can lead to a mixer output at the intermediate frequency, tunable notch filter 22 can be designed to stop frequencies in a narrow band. In the embodiment shown, the attenuation notch of the notch filter 22 is tuned together with the center frequency of the tunable bandpass filter 20, and the center frequencies of the attenuation notch filter and the tunable bandpass filter are separated by a fixed frequency which is twice the intermediate frequency.

Those skilled in the art to which the invention relates will appreciate that variations and modifications to the described examples may be made, without departing from the scope of the claimed invention.

What is claimed is:

1. A digital audio broadcast (DAB) receiver, comprising:
an antenna for receiving an RF signal;
a low noise amplifier for amplifying the received RF signal;
a tracking filter tuned to track a selected channel frequency out of the received and amplified RF signal;
a voltage controlled oscillator providing a frequency signal;
an RF mixer for mixing the oscillator frequency signal with the signal output from the tracking filter, for providing an intermediate frequency signal.

2. The receiver of claim 1, wherein the tracking filter comprises a tunable bandpass filter, a center frequency of which is tuned to track the selected channel frequency.

3. The receiver of claim 2, wherein the tracking filter comprises a tunable notch filter, an attenuation notch of which is tuned to track a frequency which is separated from the selected channel frequency by a fixed frequency.

4. The receiver of claim 3, wherein the attenuation notch of the notch filter is tuned together with the center frequency of the tunable bandpass filter, and the center frequencies of the tunable notch filter and the tunable bandpass filter are separated by a fixed frequency.

5. The receiver of claim 4, wherein the fixed frequency is about twice the intermediate frequency.

6. The receiver of claim 4, further comprising a digital signal processor and an digital-to-analog converter connected for tuning the frequency of the tracking filter by a tuning voltage generated by the digital-to-analog converter from a digital control word supplied by the digital signal processor.

7. The receiver of claim 6, wherein the digital signal processor uses a storage table with digital control words corresponding to selected channel frequencies.

8. The receiver of claim 6, wherein the tracking filter is tuned in the VHF band in a frequency range from about 174 MHz to about 240 MHz.

9. The receiver of claim 8, wherein the intermediate frequency is about 38.9 MHz.

10. A digital audio broadcast (DAB) receiver, comprising:
an antenna for receiving an RF signal;
a bandpass filter for filtering the received RF signal;
a low noise amplifier for amplifying the received and filtered RF signal;
a tracking filter tuned to track a selected channel frequency out of the amplified RF signal;
a voltage controlled oscillator providing a frequency signal;
an RF mixer connected for mixing the oscillator frequency signal with the signal output from the tracking filter, for providing an intermediate frequency signal;
an analog processor for amplifying and filtering the intermediate frequency signal;
an analog-to-digital converter for converting the amplified and filtered intermediate frequency signal to a digital signal; and
a digital signal processor receiving the digital signal and providing a digital control word signal;
a digital-to-analog converter for converting the digital word to an analog voltage signal for tuning the tracking filter;
wherein the tracking filter comprises a tunable bandpass filter and a tunable notch filter; a center frequency of the bandpass filter being tuned to track the selected channel frequency; and an attenuation notch of the notch filter being tuned to track a frequency which is separated from the selected channel frequency by a fixed frequency; the attenuation notch of the notch filter being tuned together with the center frequency of the bandpass filter, and the center frequencies of the notch filter and the bandpass filter being separated by a fixed frequency.

11. The receiver of claim 10, wherein the fixed frequency is about twice the intermediate frequency.

12. The receiver of claim 10, wherein the digital signal processor uses a storage table with digital control words corresponding to selected channel frequencies.

13. The receiver of claim 12, wherein the tracking filter is tuned in the VHF band in a frequency range from about 174 MHz to about 240 MHz.

14. The receiver of claim 13, wherein the intermediate frequency is about 38.9 MHz.

15. A method for processing an RF signal received by digital audio broadcast (DAB) receiver, comprising:
receiving an RF signal;
filtering the received RF signal using a bandpass filter;
amplifying the received and filtered RF signal using a low noise amplifier for;
tracking a selected channel frequency out of the amplified RF signal using a tracking filter;
providing a voltage controlled oscillator frequency signal;
mixing the oscillator frequency signal with the signal output from the tracking filter, providing an intermediate frequency signal;
amplifying and filtering the intermediate frequency signal;
converting the amplified and filtered intermediate frequency signal to a digital signal; and
providing a digital control word signal based on the digital signal;
using the digital word for tuning the tracking filter;
wherein the tracking filter comprises a tunable bandpass filter and a tunable notch filter; a center frequency of the bandpass filter is tuned to track the selected channel frequency; and an attenuation notch of the notch filter is tuned to track a frequency which is separated from the selected channel frequency by a fixed frequency; the attenuation notch of the notch filter is tuned together with the center frequency of the bandpass filter, and the center frequencies of the notch filter and the bandpass filter are separated by a fixed frequency.

16. The method of claim 15, wherein the fixed frequency is about twice the intermediate frequency.

17. The method of claim 15, wherein the digital control word is supplied using a digital signal processor and a storage table with digital control words corresponding to selected channel frequencies.

18. The method of claim 17, wherein the tracking filter is tuned in the VHF band in a frequency range from about 174 MHz to about 240 MHz.

19. The method of claim 18, wherein the intermediate frequency is about 38.9 MHz.

20. The method of claim 17, wherein the intermediate frequency is about 38.9 MHz.
